(19) United States
(12) Patent Application Publication
(10) Pub. No.: US 2011/0016330 A1
(43) Pub. Date: Jan. 20, 2011

(54) INFORMATION LEAK PREVENTION DEVICE, AND METHOD AND PROGRAM THEREOF

(75) Inventor: Yoshiharu Asakura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/922,809

(22) PCT Filed: Apr. 10, 2009
(86) PCT No.: PCT/JP2009/057322

§ 371 Date: Sep. 15, 2010

(30) Foreign Application Priority Data
Apr. 10, 2008 (JP) 2008-102428

(51) Int. Cl. G06F 21/00

(52) U.S. Cl. 713/189

(57) ABSTRACT

Provided is an information leak prevention device that prevents information in files from leaking without an access control rule. The information leak prevention device includes a data processing device, a file storage device and a key storage device. The data processing device includes an execution detection unit that detects the execution of the application for each user who starts the application with the use of an access identifier that is a combination of an identifier for identifying the application and an identifier for identifying the user who starts the application; a key confirmation unit that confirms whether a combination of encryption and decryption keys unique to the access identifier is in the key storage device; a key generation unit that generates the encryption and decryption keys unique to the access identifier and stores the access identifier and a combination of the encryption and decryption keys in the key storage device as a key element; an access detection unit that detects access to the file by the application for each of the users; and an encryption/decryption unit that acquires from the key storage device a combination of the encryption and decryption keys unique to the access identifier and encrypts and decrypts data with a combination of the encryption and decryption keys.

### TECHNICAL FIELD

The present invention relates to an information leak prevention device and a method and program thereof and particularly to an information leak prevention device and a method and program thereof for preventing information from leaking from a file created in a terminal by encrypting the file after making a pair of an application and a user of the application to make the file unavailable from any application other than the one used to create the file even to the user who has created the file.

### BACKGROUND ART

In recent years, the leak of files or of information in files stored in a terminal such as PC (Personal Computer) has increased due to infection with a virus. In order to prevent such a leak of files, it is effective to appropriately set privileges to access files as well as appropriately control access to files through applications on the basis of the access privileges set.

One of access control techniques that are based on the setting of access privileges and access privileges is disclosed in NPL 1. NPL 1 states discretionary access control and mandatory access control.

According to the discretionary access control, an owner of resources sets an access privilege for each attribute of an access user. An OS (Operating System) controls access by the access user to the resources on the basis of the access privileges set.

One example of the discretionary access control is the control of access to files in Linux. In Linux, an owner of files sets an access privilege of files (reading, writing or execution) for each attribute (owner, group or everyone) of a user (access user). Therefore, the setting of access privileges of files is dependent on the owner of files; the setting needs to be done for each file. Accordingly, there is no guarantee that appropriate access privileges are set for all files.

Meanwhile, in an environment where there is no rule on access control such as discretionary access control, information could leak from files due to viruses. The reason is that since access control is performed on a per-user basis according to the discretionary access control, information can be acquired from a file created by a user when a virus operates with user privileges.

According to the mandatory access control, a system administrator classifies access users and resources into stages according to security level. The system administrator then sets resources that the access users can access as well as access privileges for the resources for each security level. The setting is referred to as security policy.

The OS controls access to resources by access users on the basis of the security policy. When the security policy is appropriately set, it is possible to prevent important files or information in files from leaking even when a virus operates because resources that can be accessed are limited.

One example of the mandatory access control is the control of access to files in SELinux (Security-Enhanced Linux). What is described by an administrator in SELinux is an access control rule as to what kind of access (reading or writing, for example) to resources (files, for example) an access user (application) is allowed to have.

SELinux controls access to files by applications on the basis of the access control rule, allowing the centralized control of the settings of access privileges for resources by the administrator. However, it is necessary to describe relationships between access users, resources and access as the access control rule. The access control rule becomes more complicated as the number of access users, the types of resource and the types of access increase.

As described above, according to the discretionary access control, it is easier to manage access privileges than the mandatory access control. However, there is no guarantee that appropriate access privileges are set for all files. Therefore, information leaks could easily occur when the device is infected with viruses or the like.

Meanwhile, according to the mandatory access control, information leaks can hardly occur when infected with viruses. However, the way the access control rule is created is complicated. Maintenance needs to be made as the number of users, the number of applications (application software), the types of resource and the types of access increase or decrease.

Therefore, there is a technique of encrypting files with an encryption key and decrypting the encrypted files with a decryption key (PTL 1 to 4, for example).

### CITATION LIST

### Patent Literature

{PTL 1} JP-A-2006-262450

{PTL 2} JP-A-2007-108883

{PTL 3} JP-A-02-004037

{PTL 4} JP-A-09-134311

### Non-Patent Literature

{NPL 1} Types of access control—DAC, MAC and RBAC (http://itpro.nikkeibp.co.jp/article/COLUMN/20060526/239136/)

### SUMMARY OF INVENTION

### Technical Problem

However, the technique of PTL 1 is to generate a key from the following information: the information that is unique to a device and cannot be changed by a user, such as model name; and the information that can be changed by a user, such as administrator information. The problem with the above technique is that since a key is generated each time information is encrypted or decrypted, only common key cryptography that uses the same key for encryption and decryption can be applied.

According to the technique of PTL 2, an access privilege ID is transmitted to an access management server, a file is encrypted with an encryption key received from the access management server, and the encrypted file is stored in a predetermined area. The problem is that only a method of encrypting a file with a key stored in advance can be used.

The technique of PTL 3 is just for checking access privileges for files based on a user identifier known from packets.

The technique of PTL 4 is to generate an individual key from a medium ID read from a medium; decrypt license information read from the medium with the use of the individual key; generate a data decryption key; and decrypt encrypted data read from the medium with the data decryption key to generate original data. The technique enables the encrypted data to be kept confidential. The problem with the technique of PTL 4 is that access control, such as key generation, is complicated.

The present invention has been made in view of the above problems. The object of the present invention is to provide an information leak prevention device and a method and program thereof that prevent information in files from leaking due to viruses without the need for an access control rule like the one in the case of mandatory access control and the like.

### Solution to Problem

To solve the above problems, according to the present invention, an information leak prevention device is characterized by including: a data processing device that performs a plurality of applications for each of a plurality of users; a file storage device that stores a file associated with the execution of the application; and a key storage device that stores a combination of an encryption key and decryption key used for encrypting and decrypting data of the file, the data processing device including: an execution detection unit that detects the execution of the application for each user who starts the application with the use of an access identifier that is a combination of an identifier for identifying the application and an identifier for identifying the user who starts the application; a key confirmation unit that confirms whether a combination of encryption and decryption keys unique to the access identifier is in the key storage device; a key generation unit that generates the encryption and decryption keys unique to the access identifier when the key confirmation unit confirms that a combination of encryption and decryption keys unique to the access identifier is not in the key storage device, and stores the access identifier and a combination of the encryption and decryption keys in the key storage device as a key element; an access detection unit that detects access to the file by the application for each of the users; and an encryption/decryption unit that acquires from the key storage device a combination of the encryption and decryption keys unique to the access identifier, and encrypts and decrypts data with a combination of the acquired encryption and decryption keys.

To solve the above problems, according to the present invention, an information leak prevention method of a system including a data processing device that performs a plurality of applications for each of a plurality of users, a file storage device that stores a file associated with the execution of the application, and a key storage device that stores a combination of an encryption key and decryption key used for encrypting and decrypting data of the file is characterized by including: an execution detection step of detecting the execution of the application for each user who starts the application with the use of an access identifier that is a combination of an identifier for identifying the application and an identifier for identifying the user who starts the application; a key confirmation step of confirming whether a combination of an encryption and decryption keys unique to the access identifier is in the key storage device; a key generation step of generating a combination of encryption and decryption keys unique to the access identifier when the key confirmation step confirms that a combination of encryption and decryption keys unique to the access identifier is not in the key storage device, and storing the access identifier and a combination of the encryption and decryption keys in the key storage device as a key element; an access detection step of detecting access to the file by the application for each of the users; a step of acquiring from the key storage device a combination of the encryption and decryption keys unique to the access identifier; and an encryption/decryption step of encrypting and decrypting data with a combination of the acquired encryption and decryption keys.

To solve the above problems, according to the present invention, an information leak prevention program of a system including a data processing device that performs a plurality of applications for each of a plurality of users, a file storage device that stores a file associated with the execution of the application, and a key storage device that stores a combination of an encryption key and decryption key used for encrypting and decrypting data of the file is characterized by causing a computer to execute: an execution detection process of detecting the execution of the application for each user who starts the application with the use of an access identifier that is a combination of an identifier for identifying the application and an identifier for identifying the user who starts the application; a key confirmation process of confirming whether a combination of an encryption and decryption keys unique to the access identifier is in the key storage device; a key generation process of generating a combination of encryption and decryption keys unique to the access identifier when the key confirmation process confirms that a combination of encryption and decryption keys unique to the access identifier is not in the key storage device, and storing the access identifier and a combination of the encryption and decryption keys in the key storage device as a key element; an access detection process of detecting access to the file by the application for each of the users; a process of acquiring from the key storage device a combination of the encryption and decryption keys unique to the access identifier; and an encryption/decryption process of encrypting and decrypting data with a combination of the acquired encryption and decryption keys.

### ADVANTAGEOUS EFFECTS OF INVENTION

According to the present invention, the execution of an application is detected for each user with the use of an access identifier that is a combination of an identifier for identifying the application and an identifier for identifying the user who starts the application. When a combination of encryption and decryption keys unique to the access identifier is not in the key storage device, the encryption and decryption keys unique to the access identifier are generated. Access to the file by the application is detected for each of the users. Data is encrypted and decrypted with the encryption and decryption keys unique to the access identifier. Therefore, it is possible to obtain an information leak prevention device and a method and program thereof that prevent information in files from leaking due to viruses without the need for an access control rule like the one in the case of mandatory access control.

### BRIEF DESCRIPTION OF DRAWINGS

FIG. 1 A block diagram showing the configuration of a terminal that uses an information leak prevention device according to a first exemplary embodiment of the present invention.

FIG. 2 A flowchart illustrating the operation of an execution detection unit shown in FIG. 1.

FIG. 3 A flowchart illustrating the operation of a key confirmation unit shown in FIG. 1.

FIG. 4 A flowchart illustrating the operation of a key generation unit shown in FIG. 1.

FIG. 5 A flowchart illustrating the operation of an access detection unit shown in FIG. 1.

FIG. 6 A flowchart illustrating the operation of an encryption/decryption unit shown in FIG. 1.

FIG. 7 A block diagram illustrating a specific example of the terminal that uses the information leak prevention device shown in FIG. 1.

FIG. 8 A block diagram showing the configuration of a terminal that uses an information leak prevention device according to a second exemplary embodiment of the present invention.

FIG. 9 A flowchart illustrating the operation of an access detection unit shown in FIG. 8.

FIG. 10 A flowchart illustrating the operation of an identifier addition unit shown in FIG. 8.

FIG. 11 A block diagram illustrating a specific example of the terminal that uses the information leak prevention device shown in FIG. 8.

### DESCRIPTION OF EMBODIMENTS

The following describes an information leak prevention device and a method and program thereof according to exemplary embodiments of the present invention with reference to the accompanying drawings.

### First Exemplary Embodiment

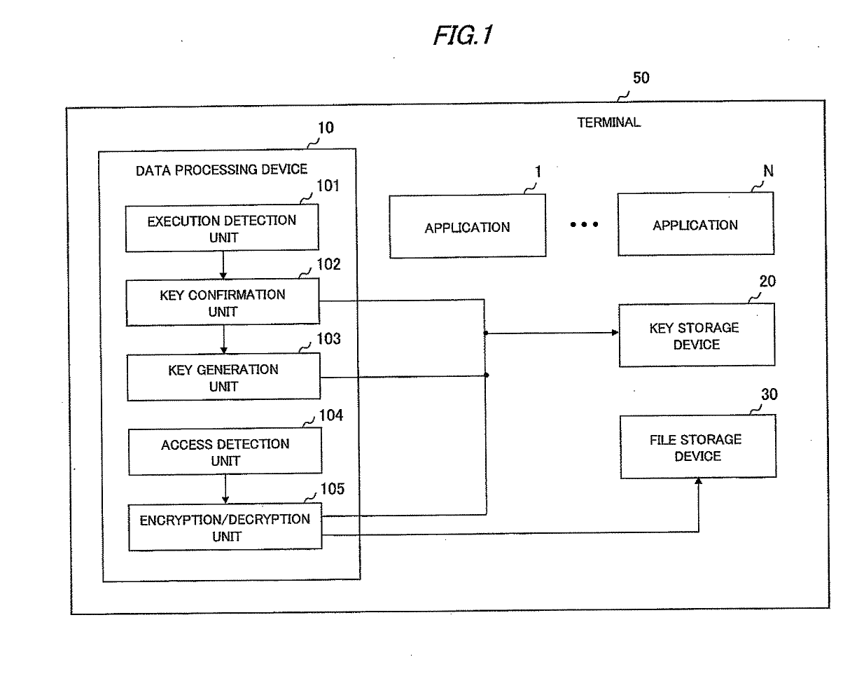

FIG. 1 is a block diagram showing the configuration of a terminal using an information leak prevention device according to a first exemplary embodiment of the present invention. In FIG. 1, the information leak prevention device of the present exemplary embodiment is installed in a terminal 50. The terminal 50 includes a data processing device 10, a key storage device 20, a file storage device 30, and a plurality of applications (application software) 1 to N.

The data processing device 10 executes a plurality of applications 1 to N for each of a plurality of users. According to the present exemplary embodiment, the data processing device 10 includes an execution detection unit 101, a key confirmation unit 102, a key generation unit 103, an access detection unit 104 and a encryption/decryption unit 105.

The execution detection unit 101 detects that an application indicated by an access identifier is executed and then transmits the access identifier to the key confirmation unit 102. Incidentally, the access identifier is a combination of an identifier for identifying a user and an identifier for identifying an application. The identifier for identifying a user may be a user ID; the identifier for identifying an application may be an execution file name of the application.

After receiving an access identifier from the execution detection unit 101, the key confirmation unit 102 confirms whether there is a key element including the access identifier in the key storage device 20. If there is no key element, the key confirmation unit 102 transmits to the key generation unit 103 the access identifier received from the execution detection unit 101. Incidentally, the key element is a combination of an access identifier and key; the key is a combination of an encryption key, which is used for encrypting data, and a decryption key, which is used for decrypting encrypted data.

After receiving the access identifier from the key confirmation unit 102, the key generation unit 103 generates a key unique to the access identifier and stores in the key storage device 20 a key element that is made up of the access identifier and the generated key.

When detecting that data is written to a file, the access detection unit 104 transmits a writing identifier to the encryption/decryption unit 105. When detecting that data is read from a file, the access detection unit 104 transmits a reading identifier to the encryption/decryption unit 105. Incidentally, the writing identifier is a combination of an access identifier, which orders writing, a file identifier and data to be written. The reading identifier is a combination of an access identifier, which orders reading, and a file identifier. The file name of the file may be used as a file identifier.

After receiving the writing identifier from the access detection unit 104, the encryption/decryption unit 105 searches the key storage device 20 for the key element having the access identifier that is included in the writing identifier. The encryption/decryption unit 105 acquires an encryption key from the key element that is extracted as a result of searching. After encrypting writing data with the encryption key, the encryption/decryption unit 105 writes the encrypted data to the file indicated by the file identifier on the file storage device 30.

After receiving the reading identifier from the access detection unit 104, the encryption/decryption unit 105 searches the key storage device 20 for the key element having the access identifier that is included in the reading identifier. The encryption/decryption unit 105 acquires an decryption key from the key element that is extracted as a result of searching. After decrypting, with the use of the decryption key, data read from the file indicated by the file identifier on the file storage device 30, the encryption/decryption unit 105 sends the decrypted data to an application indicated by the access identifier.

The key storage device 20 stores the above key element.

The file storage device 30 stores a file generated by the application.

The following describes in detail the overall operation of the information leak prevention device according to the present exemplary embodiment with reference to FIGS. 1 to 6. Incidentally, suppose that no key element is registered in the key storage device 20.

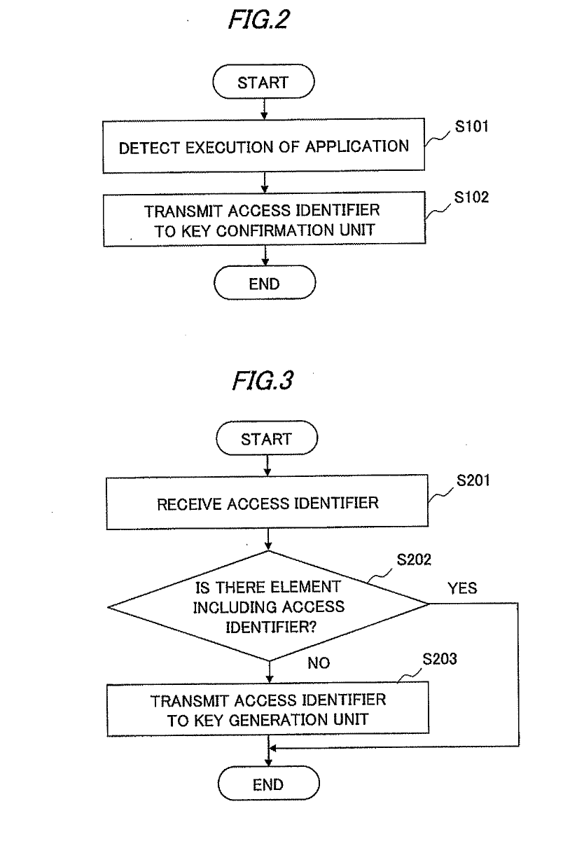

FIG. 2 is a flowchart illustrating the operation of the execution detection unit 101 shown in FIG. 1. Suppose that a user A (not shown) starts an application M (1≦M≦N). An access identifier that is made up of the user A and the application M is represented by an access identifier α (not shown).

After detecting that the application M is executed (Step S101), the execution detection unit 101 transmits the access identifier α to the key confirmation unit 102 (Step S102).

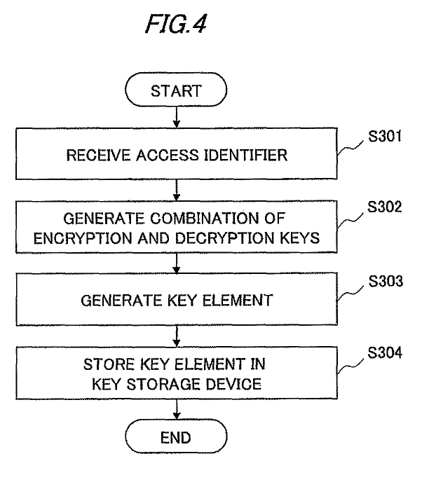

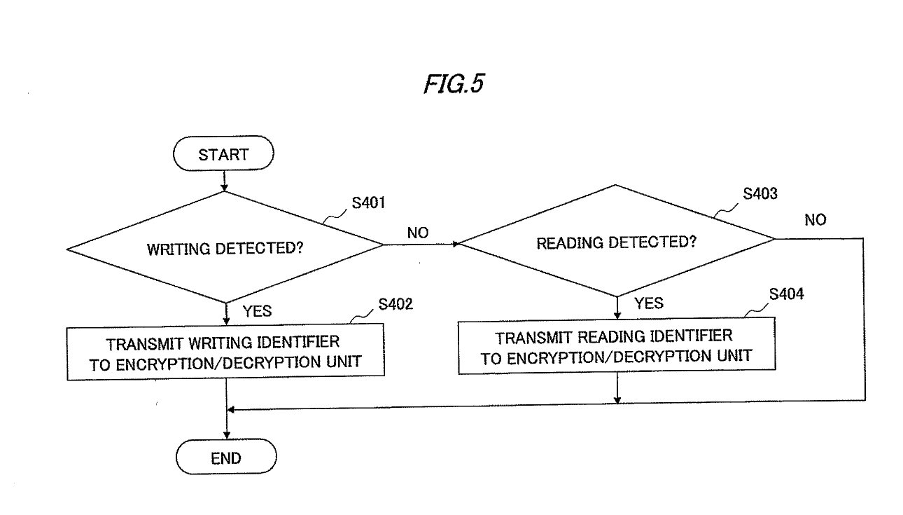

FIG. 3 is a flowchart illustrating the operation of the key confirmation unit 102 shown in FIG. 1. As shown in FIG. 4, after receiving the access identifier α (Step S201), the key confirmation unit 102 confirms whether there is a key element including the access identifier α in the key storage device 20 (Step S202).

As described above, there is no key element stored in the key storage device 20. Therefore, the key confirmation unit 102 transmits the access identifier α to the key generation unit 103 (Step S203).

Meanwhile, if there is a key element stored in the key storage device 20 at step S202 (YES), the key confirmation unit 102 ends the process of FIG. 3 without transmitting the access identifier α to the key generation unit 103.

FIG. 4 is a flowchart illustrating the operation of the key generation unit 103 illustrated in FIG. 1. As shown in FIG. 4, after receiving the access identifier a from the key confirmation unit 102 (Step S301), the key generation unit 103 generates a key α1 (which is a combination of an encryption key α2 and decryption key α3) unique to the access identifier α (Step S302) and generates a key element α4 consisting of the access identifier α and the key α1 (Step S303). The key generation unit 103 then stores the key element α4 in the key storage device 20 (Step S304).

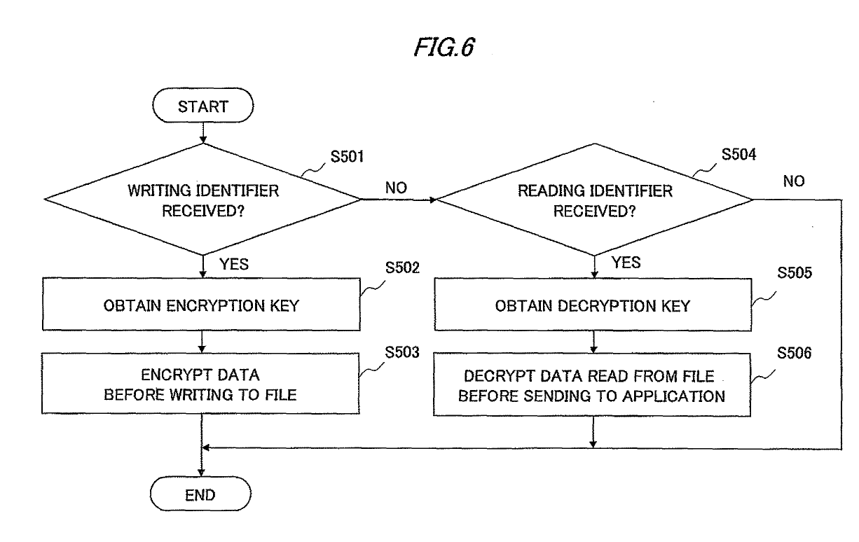

The following describes a case where the application M is about to write data 1 (not shown) to a file 1 (not shown) having the file identifier 1 (not shown) with reference to FIGS. 5 and 6. FIG. 5 is a flowchart illustrating the operation of the access detection unit 104 shown in FIG. 1. FIG. 6 is a flowchart illustrating the operation of the encryption/decryption unit 105 shown in FIG. 1.

At step S401 of FIG. 5, after detecting that data is written to the file 1 (YES), the access detection unit 104 transmits to the encryption/decryption unit 105 a writing identifier 1 (not shown) consisting of the access identifier α, the file identifier 1 and the data 1 (Step S402).

As shown in FIG. 6, after receiving the writing identifier 1 (Step S501), the encryption/decryption unit 105 searches the key storage device 20 for the key element α4 containing the access identifier α and acquires the encryption key α2 from the key element α4 (Step S502).

Moreover, after encrypting the data 1 with the acquired encryption key α2, the encryption/decryption unit 105 writes the encrypted data 1 to the file 1 on the file storage device 30 (Step S503).

The following describes a case where the application M is about to read data 2 (not shown) from the file 1 having the file identifier 1 with reference to FIGS. 5 and 6.

At step S401 of FIG. 5, when not detecting that data is written to the file 1 (NO), the access detection unit 104 at step S403 confirms whether it is detected that data is read. When it is detected that data is read (YES), the access detection unit 104 transmits to the encryption/decryption unit 105 a reading identifier 1 (not shown) consisting of the access identifier α and the file identifier 1 (Step S404).

Incidentally, when it is not detected at step S403 that data is read (NO), the access detection unit 104 ends the process of FIG. 6 without transmitting the writing or reading identifier to the encryption/decryption unit 105.

When not receiving the writing identifier at step S501 of FIG. 6 (NO), the encryption/decryption unit 105 confirms whether the reading identifier 1 has been received at step S504. When the reading identifier 1 has been received (YES), the encryption/decryption unit 105 searches the key storage device 20 for the key element α4 containing the access identifier α and obtains the decryption key α3 from the key element α4 (Step S505).

The encryption/decryption unit 105 then decrypts the data 2 read out from the file 1 on the file storage device 30 with the use of the decryption key α3 and sends the decrypted data 2 to the application M (Step S506).

Incidentally, when the reading identifier is not received at step S504 (NO), the encryption/decryption unit 105 ends the process of FIG. 6 without encrypting or decrypting data.

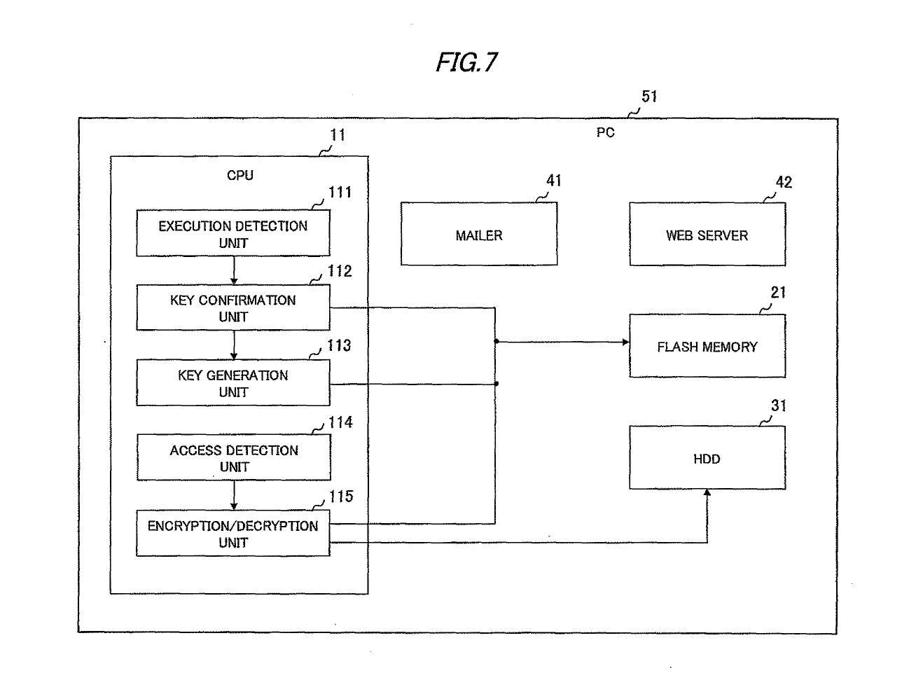

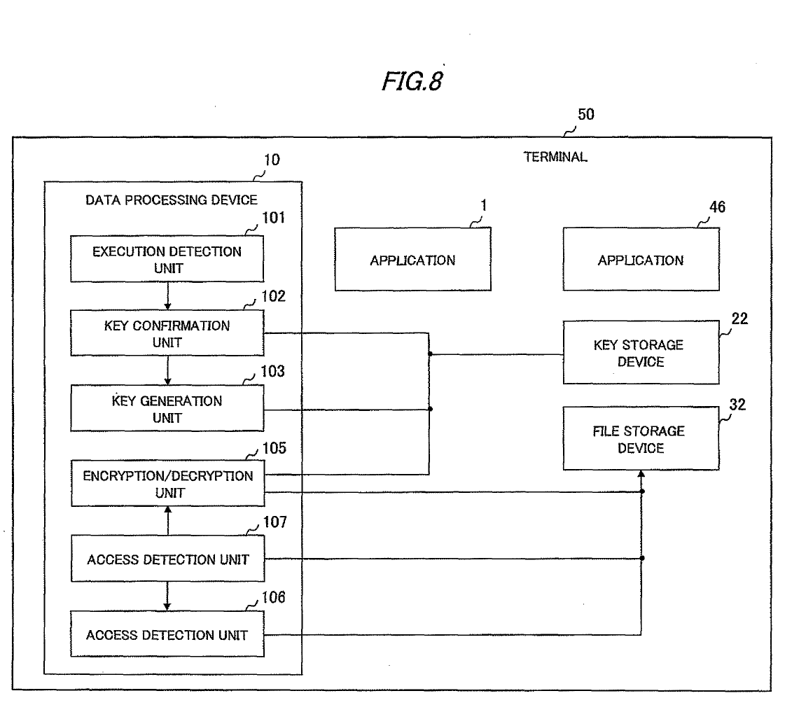

The following describes a specific example of a terminal that uses the information leak prevention device shown in FIG. 1 according to the present exemplary embodiment with reference to FIG. 7.

As one example, the terminal 50 shown in FIG. 1 is applied to a PC (Personal Computer) 51 shown in FIG. 7. The PC 51 includes a CPU (Central Processing Unit) 11, which serves as a data processing device and is operated by program control; a Flash memory 21, which serves as a key storage device and is a rewritable nonvolatile memory; a HDD (Hard Disk Drive) 31, which serves as a file storage device; and a mailer 41 and WEB server 42, which are part of a plurality of applications.

In the example shown in FIG. 7, the CPU 11 acts as an execution detection unit 111, key confirmation unit 112, key generation unit 113, access detection unit 114 and encryption/decryption unit 115. A program that serves as each of the units 111 to 115 to run the CPU 11 is stored in a storage device (not shown) as an information leak prevention program: programs inside the PC 51 are to be stored in the storage device.

Suppose that an access identifier that is made up of a user A and the mailer 41 is AID1. Also, suppose no key element is stored in the Flash memory 21 and that a file name is used as a file identifier.

Suppose that the user A has started the mailer 41. After detecting that the mailer 41 has started, the execution detection unit 111 transmits AID1 to the key confirmation unit 112.

After receiving AID1, the key confirmation unit 112 confirms whether there is a key element containing AID1 in the Flash memory 21. Since there is no key element in the Flash memory 21, the key confirmation unit 112 transmits AID1 to the key generation unit 113.

After receiving AID1, the key generation unit 113 generates KEY1 that is unique to AID1 and consists of an encryption key 1 and a decryption key 1. Suppose that the encryption key 1 and decryption key 1 are a secret key 1 and public key 1, respectively. The key generation unit 113 stores in the Flash memory 21 a key element 1 consisting of AID1 and KEY1.

Suppose that the mailer 41 is about to write data 1 to a file 1, whose name is “/mail/mail01,” on the HDD31.

After detecting that the data is written to the file 1, the access detection unit 114 transmits to the encryption/decryption unit 115 a writing identifier WID1 consisting of AID1, “/mail/mail01,” and the data 1.

After receiving WID1, the encryption/decryption unit 115 searches the Flash memory 21 for the key element 1 containing AID1 and obtains the secret key 1 from the key element 1. After encrypting the data 1 with the acquired secret key 1, the encryption/decryption unit 115 writes the encrypted data 1 to the file 1 on the HDD 31.

Suppose that the mailer 41 reads data 2 from the file 1 on the HDD 31.

After detecting data is read from the file 1, the access detection unit 114 transmits to the encryption/decryption unit 115 a reading identifier RID1 consisting of AID1 and “/mail/mail01.”

After receiving RID1, the encryption/decryption unit 115 searches the Flash memory 21 for the key element 1 containing AID1 and obtains the public key 1 from the key element 1. After reading the encrypted data 2 from the file 1, the encryption/decryption unit 115 decrypts the data 2 with the public key 1 and sends the decrypted data 2 to the mailer 41.

Suppose the user A starts the WEB server 42. In this case, suppose an access identifier consisting of the user A and the WEB server 42 is AID2.

After detecting that the WEB server 42 has started, the execution detection unit 111 transmits AID2 to the key confirmation unit 112.

After receiving AID2, the key confirmation unit 112 confirms whether there is a key element containing AID2 in the Flash memory 21. Since there is no key element containing AID2 in the Flash memory 21, the key confirmation unit 112 transmits AID2 to the key generation unit 113.

After receiving AID2, the key generation unit 113 generates KEY2 that is unique to AID2 and consists of an encryption key 2 and a decryption key 2. Suppose that the encryption key 2 and decryption key 2 are a secret key 2 and public key 2, respectively. The key generation unit 113 stores in the Flash memory 21 a key element 2 consisting of AID2 and KEY2.

Suppose that the WEB server 42 is about to read data 3 from the file 1 on the HDD31.

After detecting that the data 3 is read from the file 1, the access detection unit 114 transmits to the encryption/decryption unit 115 a reading identifier RID2 consisting of AID2, and “/mail/mail01.”

After receiving RID2, the encryption/decryption unit 115 searches the Flash memory 21 for the key element 2 containing AID2 and obtains the public key 2 from the key element 2. After reading the encrypted data 3 from the file 2, the encryption/decryption unit 115 makes an attempt to decrypt the data 3 with the public key 2. Since the data 3 is encrypted with the secret key 1, the decrypting with the public key 2 fails. Therefore, the encrypted data 3 is sent to the WEB server 42 without change.

As described above, according to the present exemplary embodiment, data to be written to a file is encrypted with a unique encryption key determined by a combination of a user and application. Therefore, even if a file leaks, there is no fear that data inside the file is read. Moreover, it is only a combination of a user and application that can decrypt the encrypted data. Therefore, even if the device is infected with a virus that operates with user privileges, it is not possible for the virus to decrypt the data inside the file. Therefore, it is possible to prevent data inside files from leaking
Moreover, data in a file is encrypted with a unique encryption key determined by a combination of a user and application. The encrypted data can be decrypted only by a combination of a user who writes the data and an application. Therefore, it is possible to keep data from leaking without the control of access to files by applications. Thus, access control rules are unnecessary.

Moreover, keys used for encrypting and decrypting data inside files are automatically generated in such a way that the keys are uniquely determined from a combination of a user and application. Therefore, it is unnecessary for encryption and decryption keys to be prepared in advance. Maintenance is unnecessary even as the number of users or applications increases.

### Second Exemplary Embodiment

The following describes in detail a second exemplary embodiment of the present invention with reference to the accompanying drawings. FIG. 8 is a block diagram illustrating the configuration of a terminal that uses the information leak prevention device according to the present exemplary embodiment.

With reference to FIG. 8, according to the present exemplary embodiment, in addition to the components of the first exemplary embodiment, a new identifier addition unit 106 is provided to add an access identifier that orders the creation of a file to the file.

Moreover, an access detection unit 107 is provided instead of the access detection unit 104 of the present exemplary embodiment.

After detecting that a file is created, the access detection unit 107 transmits to the identifier addition unit 106 the access identifier that orders the creation of the file and a file identifier.

After detecting that data is written to the file, the access detection unit 107 examines whether the access identifier that orders the writing of data is added to the file indicated by the file identifier. When the access identifier is added to the file, the access detection unit 107 transmits a writing identifier to the encryption/decryption unit 105. When the access identifier is not added to the file, the access detection unit 107 returns an error identifier to the application indicated by the access identifier.

After detecting that data is read from the file, the access detection unit 107 examines whether the access identifier that orders the reading of data is added to the file indicated by the file identifier. When the access identifier is added to the file, the access detection unit 107 transmits a reading identifier to the encryption/decryption unit 105. If the access identifier is not added to the file, the access detection unit 107 returns an error identifier to the application indicated by the access identifier.

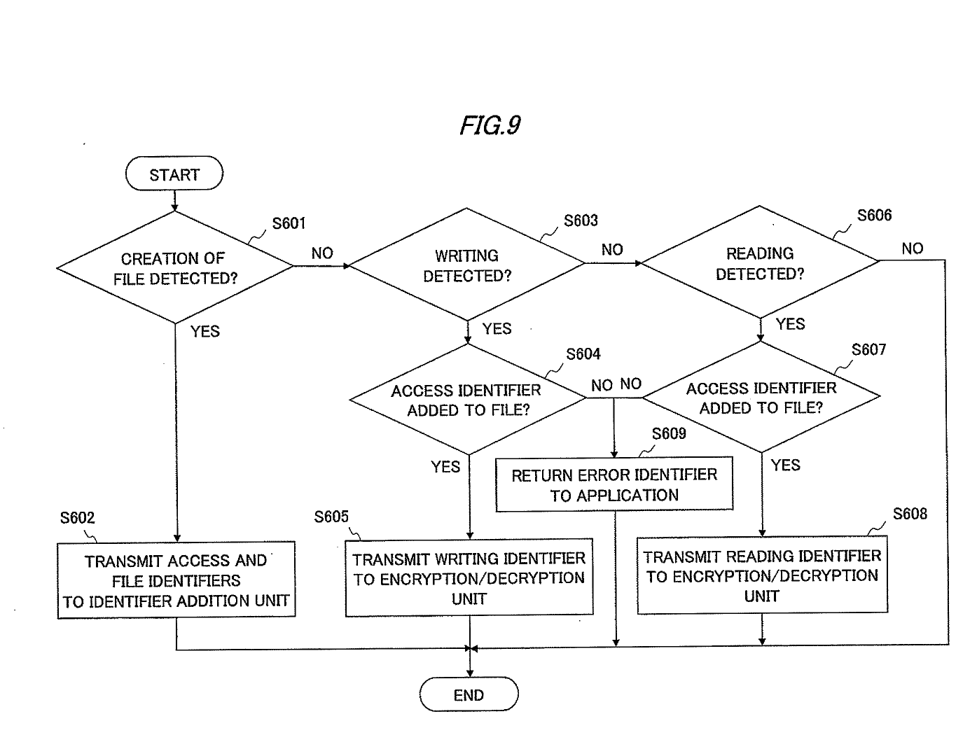

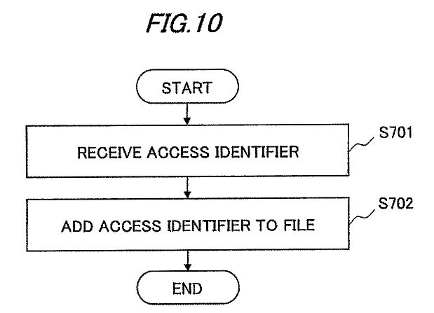

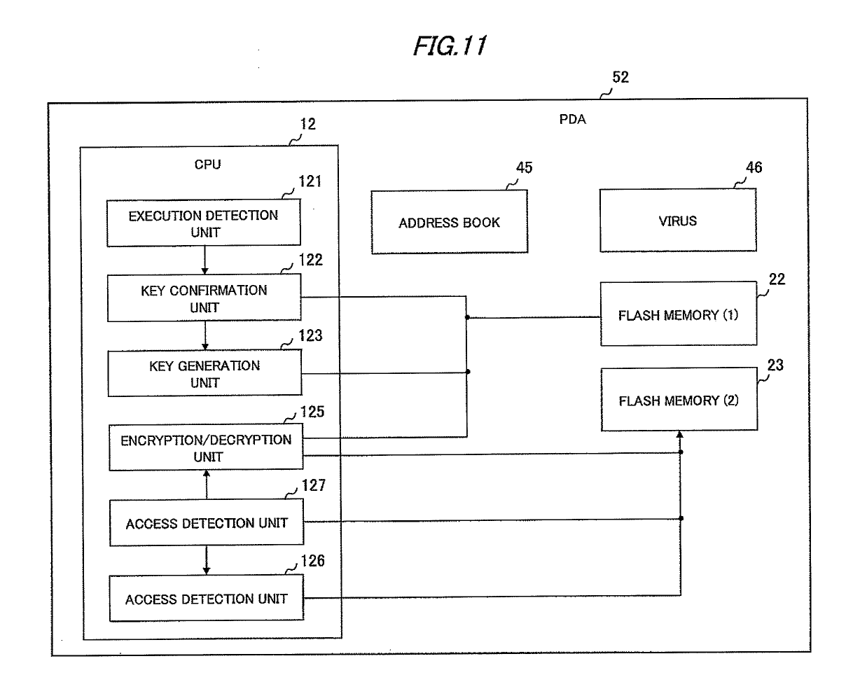

The following describes in detail the overall operation of the present exemplary embodiment with reference to FIGS. 8, 9 and 10. FIG. 9 is a flowchart illustrating the operation of the access detection unit 107 shown in FIG. 8. FIG. 10 is a flowchart illustrating the operation of the identifier addition unit 106 shown in FIG. 8.

Incidentally, the overall operation of the present exemplary embodiment is the same as that of the first exemplary embodiment except for the identifier addition unit 106 and the access detection unit 107 and therefore will not be described in detail here.

Suppose an access identifier consisting of the user A (not shown) and the application M (1≦M≦N) is regarded as an access identifier α. Also suppose that the application M started by the user A makes an attempt to create a file 2 having a file identifier 2 (not shown).

As shown in FIG. 9, after detecting that the file 2 is created (Step S601), the access detection unit 107 transmits to the identifier addition unit 106 the file identifier 2 and the access identifier α that orders the creation of the file 2 (Step S602).

As shown in FIG. 10, after receiving the access identifier α from the access detection unit 107 (Step S701), the identifier addition unit 106 adds the access identifier α to the file 2 having the file identifier 2 (Step S702).

Suppose that the application M is about to write data to the file 2.

When the creation of the file is not detected at step S601 of FIG. 9 (NO), the access detection unit 107 confirms whether it is detected at step S603 that data is written to the file 2. When it is detected that data is written to the file 2 (YES), the access detection unit 107 examines whether the access identifier α is added to the file 2 (Step S604).

Since the access identifier α is added to the file 2, the access detection unit 107 transmits a writing identifier 2 (not shown) consisting of the access identifier α, file identifier 2 and writing data 2 (not shown) to the encryption/decryption unit 105 (Step S605).

Meanwhile, when the access identifier is not added to the file at step S604, the access detection unit 107 returns an error identifier to the application M (Step S609).

When it is not detected at step S606 of FIG. 9 that data is written to the file (NO), the access detection unit 107 confirms whether it is detected that data is read from the file 2. When it is detected that data is read from the file 2 (YES), the access detection unit 107 examines whether the access identifier α is added to the file 2 (Step S607).

Since the access identifier α is added to the file 2, the access detection unit 107 transmits a reading identifier 2 (not shown) consisting of the access identifier α and file identifier 2 to the encryption/decryption unit 105 (Step S608).

Meanwhile, when the access identifier is not added at step S607, the access detection unit 107 returns an error identifier to the application M (Step S609).

Incidentally, when it is not detected at step S606 that data is read from the file (NO), the access detection unit 107 ends the process of FIG. 9.

The following describes a specific example of the terminal 50 that uses the information leak prevention device shown in FIGS. 8 and 1 according to the present exemplary embodiment with reference to FIG. 11.

As one example, the terminal 50 shown in FIG. 8 is applied to a PDA (Personal Digital Assistant) 52 shown in FIG. 11. The PDA 52 includes a CPU (Central Processing Unit) 12, which serves as a data processing device and is operated by program control; a Flash memory (1) 22, which serves as a key storage device and is a rewritable nonvolatile memory; a Flash memory (2) 23, which serves as a file storage device; and an address book 45 and virus 46, which are part of a plurality of applications.

In the example shown in FIG. 11, the CPU 12 acts as an execution detection unit 121, key confirmation unit 122, key generation unit 123, access detection unit 127, encryption/decryption unit 125 and identifier addition unit 126. A program that serves as each of the units 121 to 126 to run the CPU 11 is stored in a storage device (not shown) as an information leak prevention program: programs inside the PDA 52 are to be stored in the storage device.

Suppose that an access identifier that is made up of the user A and the address book 45 is AID1. Also, suppose that a key element 1 having AID1 and KEY1, which consists of an encryption key 1 and decryption key 1 unique to AID1, is stored in the Flash memory (1) 22. In this case, a common key 1 serves as the encryption key 1 and decryption key 1 (i.e. Encryption key 1=Decryption key 1).

Moreover, suppose a file system of the Flash memory (2) 23 has an area where files are linked to access identifiers and that file names are used as file identifiers.

Suppose the user A has started the address book 45. After detecting that the address book 45 has been started, the execution detection unit 121 transmits AID1 to the key confirmation unit 122.

After receiving AID1, the key confirmation unit 122 confirms whether there is a key element containing AID1 in the Flash memory (1) 22. Since the key element 1 is stored in the Flash memory (1) 22, the key confirmation unit 122 does not transmit AID1 to the key generation unit 123.

Suppose that the address book 45 makes an attempt to create a file 1 whose name is “/addr/addr01.”

After detecting that the file 1 is created, the access detection unit 127 transmits to the identifier addition unit 126 “/addr/addr01” and AID1 that orders the creation of the file 1.

The identifier addition unit 126 adds AID1 to the file 1 whose name is “/addr/addr01” (The file 1 and AID1 are linked to one another on the file system of the Flash memory (2) 23).

Suppose the address book 45 is about to write data 1 to the file 1 whose name is “/addr/addr01” on the Flash memory (2) 23.

After detecting that data is written to the file 1, the access detection unit 127 examines whether AID1 is added to the file 1. Since AID1 is added to the file 1, the access detection unit 127 transmits to the encryption/decryption unit 125 a writing identifier WID1 consisting of AID1 and “/addr/addr01.”

After receiving WID1, the encryption/decryption unit 125 searches the Flash memory (1) 22 for the key element 1 containing AID1 and obtains the common key 1 from the key element 1. After encrypting the data 1 with the obtained common key 1, the encryption/decryption unit 125 writes the encrypted data 1 to the file 1 on the Flash memory (2) 23.

Suppose the virus 46 has started with privileges of the user A. In this case, suppose an access identifier consisting of the user A and the virus 46 is AID2.

After detecting that the virus has been started, the execution detection unit 121 transmits AID2 to the key confirmation unit 122.

After receiving AID2, the key confirmation unit 122 makes an attempt to acquire a key element containing AID2 from the Flash memory (1) 22. Since there is no key element containing AID2 stored in the Flash memory, the key confirmation unit 122 transmits AID2 to the key generation unit 123.

After receiving AID2, the key generation unit 123 generates KEY2 consisting of an encryption key 2 and decryption key 2 unique to AID2. In this case, a common key 2 serves as the encryption key 2 and decryption key 2. The key generation unit 123 stores in the Flash memory (1) 22 a key element 2 consisting of AID2 and KEY2.

Suppose the virus 46 is about to read data 2 from the file 1 on the Flash memory (2) 23.

After detecting that data is read from the file 1, the access detection unit 127 examines whether AID2 is added to the file 1. Since AID2 is not added to the file 1, the access detection unit 127 returns an error identifier to the virus 46.

As described above, according to the present exemplary embodiment, in addition to the effects of the first exemplary embodiment, it is possible only for a combination of a user and application that have created the file to access the file. Therefore, it is possible to prevent data in the file from being altered by the other combinations of users and applications.

If decryption is impossible when data is read from the file, reading access is denied. Therefore, an application does not read meaningless data that is not decrypted. As a result, such devices as PDA of the present exemplary embodiment improve in performance.

In the information leak prevention device of each of the above exemplary embodiments, the following are used as examples for description: the Flash memory and HDD, which serve as a key storage device and file storage device, respectively; the mailer and WEB server or address book and virus, which serve as applications; and the PC or PDA, which serves as a terminal. However, the key storage device, file storage device, applications and terminal are not limited to the above examples and may be others.

Incidentally, the information leak prevention device of each of the above exemplary embodiments can be realized by hardware, software or a combination of both. However, the hardware or software configuration is not limited to a specific form. Any form can be applied as long as there are the data processing device, file storage device and key storage device as described above and the functions of the units of the data processing device can be realized. For example, the following structures can be applied: a structure that has independent, separate circuits and components (software modules and the like) for the functions of the units of the data processing device; and a structure in which a plurality of functions are integrated into one circuit or component.

When the functions of the units of the data processing device are realized by program codes, the program codes and a recording medium for storing the program codes come within the scope of the present invention. In this case, when the functions of the units are realized by the program codes as well as by other software programs such as Operating System (OS), the program codes of the software programs are also included.

The above has described the present invention with reference to the exemplary embodiments. However, the present invention is not limited to the above exemplary embodiments. Various modifications apparent to those skilled in the art may be made in the configuration and details of the present invention without departing from the scope of the present invention.

The present application claims priority from Japanese Patent Application No. 2008-102428 filed on Apr. 10, 2008, the entire contents of which being incorporated herein by reference.

### INDUSTRIAL APPLICABILITY

The present invention can be applied for use in an information leak prevention device and a method and program thereof that generate a unique encryption key and decryption key for each of combinations of users and applications, encrypt data to be recorded in files for each of the combinations of users and applications, keep other combinations of users and applications from accessing the files, and prevent the data recorded in the files from leaking. The present invention can also be applied for use in such terminals as PC and PDA that use the information leak prevention device.

### REFERENCE SIGNS LIST

1 to N, M: Application
10: Data processing device
11, 12: CPU
20: Key storage device
21: Flash memory
22: Flash memory (1)
23: Flash memory (2)
30: File storage device
31: HDD
41: Mailer
42: Web server
45: Address book
46: Virus
50: Terminal
51: PC
52: PDA
101: Execution detection unit
102: Key confirmation unit
103: Key generation unit
104, 107: Access detection unit
105: Encryption/decryption unit
106: Identifier addition unit
111: Execution detection unit
112: Key confirmation unit
113: Key generation unit
114: Access detection unit
115: Encryption/decryption unit
121: Execution detection unit
122: Key confirmation unit
123: Key generation unit
125: Encryption/decryption unit
126: Identifier addition unit
127: Access detection unit

1. An information leak prevention device comprising:
a data processing device that performs a plurality of applications for each of a plurality of users;
a file storage device that stores a file associated with the execution of the application; and
a key storage device that stores a combination of an encryption key and decryption key used for encrypting and decrypting data of the file,
the data processing device including:
an execution detection unit that detects the execution of the application for each user who starts the application with the use of an access identifier that is a combination of an identifier for identifying the application and an identifier for identifying the user who starts the application;
a key confirmation unit that confirms whether a combination of encryption and decryption keys unique to the access identifier is in the key storage device;
a key generation unit that generates the encryption and decryption keys unique to the access identifier when the key confirmation unit confirms that a combination of encryption and decryption keys unique to the access identifier is not in the key storage device, and stores the access identifier and a combination of the encryption and decryption keys in the key storage device as a key element;
an access detection unit that detects access to the file by the application for each of the users; and
an encryption/decryption unit that acquires from the key storage device a combination of the encryption and decryption keys unique to the access identifier, and encrypts and decrypts data with a combination of the acquired encryption and decryption keys.

2. The information leak prevention device according to claim 1, wherein:
the execution detection unit transmits the detected access identifier to the key confirmation unit; and
the key confirmation unit confirms whether the key element containing the received access identifier is in the key storage device.

3. The information leak prevention device according to claim 1, wherein:
the key confirmation unit transmits the access identifier to the key generation unit when a key element containing an access identifier received from the execution detection unit is not in the key storage device; and
the key generation unit generates a combination of the encryption and decryption keys unique to the received access identifier, and stores the access identifier and a combination of the encryption and decryption keys in the key storage device as the key element.

4. The information leak prevention device according to claim 1, wherein:
the access detection unit transmits to the encryption/decryption unit a writing identifier consisting of the access identifier, a file identifier of the file and data to be written after detecting that the data is written to the file by the application; and
the encryption/decryption unit searches the key storage device for the access identifier that is included in the received writing identifier, acquires the encryption key from the key element extracted by the searching, and writes to the file the data encrypted with the acquired encryption key.

5. The information leak prevention device according to claim 1, wherein:
the access detection unit transmits to the encryption/decryption unit a reading identifier consisting of the access identifier and a file identifier of the file after detecting that data is read from the file by the application; and
the encryption/decryption unit searches the key storage device for the access identifier that is included in the received reading identifier, acquires the decryption key from the key element extracted by the searching, decrypts data read from the file with the acquired decryption key, and sends the data to the application.

6. The information leak prevention device according to claim 1, wherein
the encryption and decryption keys each are a secret or public key, or the encryption and decryption keys are a common key.

7. The information leak prevention device according to claim 4, wherein
the file identifier is a full path name of the file.

8. The information leak prevention device according to claim 1, wherein
the access identifier contains an execution file name of the application as an identifier for identifying the application and an ID of the user as an identifier for identifying the user.

9. The information leak prevention device according to claim 1, wherein
the data processing device further includes an identifier addition unit that adds the access identifier to a file.

10. The information leak prevention device according to claim 9, wherein:
the access detection unit transmits to the identifier addition unit the access identifier and a file identifier of a file after detecting the creation of the file by the application; and
the identifier addition unit adds the received access identifier to a file having the received file identifier.

11. The information leak prevention device according to claim 9, wherein:
the access detection unit examines whether the access identifier is added to the file after detecting that data is written to the file by the application, and transmits to the encryption/decryption unit a writing identifier consisting of the access identifier, file identifier and data to be written when the access identifier is added to the file while returning an error identifier to the application when the access identifier is not added to the file; and
the encryption/decryption unit searches the key storage device for the access identifier that is included in the received writing identifier, acquires the encryption key from the key element extracted by the searching, and writes to the file the data encrypted with the acquired encryption key.

12. The information leak prevention device according to claim 9, wherein:
the access detection unit examines whether the access identifier is added to the file after detecting that data is read from the file by the application, and transmits to the encryption/decryption unit a reading identifier consisting of the access identifier and file identifier when the access identifier is added to the file while returning an error identifier to the application when the access identifier is not added to the file; and
the encryption/decryption unit searches the key storage device for the access identifier that is included in the received reading identifier, acquires the decryption key from the key element extracted by the searching, decrypts data read from the file with the acquired decryption key, and sends the data to the application.

13. The information leak prevention device according to claim 11, wherein
the encryption and decryption keys each are a secret or public key, or the encryption and decryption keys are a common key.

14. The information leak prevention device according to claim 10, wherein
the file identifier is a full path name of the file.

15. The information leak prevention device according to claim 9, wherein
the access identifier contains an execution file name of the application as an identifier for identifying the application and an ID of the user as an identifier for identifying the user.

16. An information leak prevention method of a system including a data processing device that performs a plurality of applications for each of a plurality of users, a file storage device that stores a file associated with the execution of the application, and a key storage device that stores a combination of an encryption key and decryption key used for encrypting and decrypting data of the file, the method comprising:
an execution detection step of detecting the execution of the application for each user who starts the application with the use of an access identifier that is a combination of an identifier for identifying the application and an identifier for identifying the user who starts the application;
a key confirmation step of confirming whether a combination of an encryption and decryption keys unique to the access identifier is in the key storage device;
a key generation step of generating a combination of encryption and decryption keys unique to the access identifier when the key confirmation step confirms that a combination of encryption and decryption keys unique to the access identifier is not in the key storage device, and storing the access identifier and a combination of the encryption and decryption keys in the key storage device as a key element;
an access detection step of detecting access to the file by the application for each of the users;
a step of acquiring from the key storage device a combination of the encryption and decryption keys unique to the access identifier; and
an encryption/decryption step of encrypting and decrypting data with a combination of the acquired encryption and decryption keys.

17. The information leak prevention method according to claim 16, wherein:
the access detection step transfers to the encryption/decryption step a writing identifier consisting of the access identifier, a file identifier of the file and data to be written after detecting that the data is written to the file by the application; and
the encryption/decryption step searches the key storage device for the access identifier that is included in the writing identifier, acquires the encryption key from the key element extracted by the searching, and writes to the file the data encrypted with the acquired encryption key.

18. The information leak prevention method according to claim 16, wherein:
the access detection step transfers to the encryption/decryption step a reading identifier consisting of the access identifier and a file identifier of the file after detecting that data is read from the file by the application; and
the encryption/decryption step searches the key storage device for the access identifier that is included in the received reading identifier, acquires the decryption key from the key element extracted by the searching, decrypts data read from the file with the acquired decryption key, and sends the data to the application.

19. The information leak prevention method according to claim 16, wherein
the encryption and decryption keys each are a secret or public key, or the encryption and decryption keys are a common key.

20. The information leak prevention method according to claim 17, wherein
the file identifier is a full path name of the file.

21. The information leak prevention method according to claim 16, wherein
the access identifier contains an execution file name of the application as an identifier for identifying the application and an ID of the user as an identifier for identifying the user.

22. The information leak prevention method according to claim 16, further comprising
an identifier addition step of adding the access identifier to a file, wherein
the access detection step transfers to the identifier addition step the access identifier and a file identifier of a file after detecting the creation of the file by the application; and
the identifier addition step adds the access identifier to a file having the file identifier.

23. The information leak prevention method according to claim 22, wherein:
the access detection step examines whether the access identifier is added to the file after detecting that data is written to the file by the application, and transfers to the encryption/decryption step a writing identifier consisting of the access identifier, file identifier and data to be written when the access identifier is added to the file while returning an error identifier to the application when the access identifier is not added to the file; and
the encryption/decryption step searches the key storage device for the access identifier that is included in the writing identifier, acquires the encryption key from the key element extracted by the searching, and writes to the file the data encrypted with the acquired encryption key.

24. The information leak prevention method according to claim 22, wherein:
the access detection step examines whether the access identifier is added to the file after detecting that data is read from the file by the application, and transfers to the encryption/decryption step a reading identifier consisting of the access identifier and file identifier when the access identifier is added to the file while returning an error identifier to the application when the access identifier is not added to the file; and
the encryption/decryption step searches the key storage device for the access identifier that is included in the reading identifier, acquires the decryption key from the key element extracted by the searching, decrypts data read from the file with the acquired decryption key, and sends the data to the application.

25. The information leak prevention method according to claim 23, wherein
the encryption and decryption keys each are a secret or public key, or the encryption and decryption keys are a common key.

26. The information leak prevention method according to claim 22, wherein
the file identifier is a full path name of the file.

27. The information leak prevention method according to claim 22, wherein
the access identifier contains an execution file name of the application as an identifier for identifying the application and an ID of the user as an identifier for identifying the user.

28. A computer-readable medium stored therein an information leak prevention program of a system including a data processing device that performs a plurality of applications for each of a plurality of users, a file storage device that stores a file associated with the execution of the application, and a key storage device that stores a combination of an encryption key and decryption key used for encrypting and decrypting data of the file, causing a computer to execute:
an execution detection process of detecting the execution of the application for each user who starts the application with the use of an access identifier that is a combination of an identifier for identifying the application and an identifier for identifying the user who starts the application;
a key confirmation process of confirming whether a combination of an encryption and decryption keys unique to the access identifier is in the key storage device;
a key generation process of generating a combination of encryption and decryption keys unique to the access identifier when the key confirmation process confirms that a combination of encryption and decryption keys unique to the access identifier is not in the key storage device, and storing the access identifier and a combination of the encryption and decryption keys in the key storage device as a key element;
an access detection process of detecting access to the file by the application for each of the users;
a process of acquiring from the key storage device a combination of the encryption and decryption keys unique to the access identifier; and
an encryption/decryption process of encrypting and decrypting data with a combination of the acquired encryption and decryption keys.

29. The computer-readable medium according to claim 28, wherein:
the access detection process transfers to the encryption/decryption process a writing identifier consisting of the access identifier, a file identifier of the file and data to be written after detecting that the data is written to the file by the application; and
the encryption/decryption process searches the key storage device for the access identifier that is included in the writing identifier, acquires the encryption key from the key element extracted by the searching, and writes to the file the data encrypted with the acquired encryption key.

30. The computer-readable medium according to claim 28, wherein:
the access detection process transfers to the encryption/decryption process a reading identifier consisting of the access identifier and a file identifier of the file after detecting that data is read from the file by the application; and
the encryption/decryption process searches the key storage device for the access identifier that is included in the received reading identifier, acquires the decryption key from the key element extracted by the searching, decrypts data read from the file with the acquired decryption key, and sends the data to the application.

31. The computer-readable medium according to claim 28, wherein
the encryption and decryption keys each are a secret or public key, or the encryption and decryption keys are a common key.

32. The computer-readable medium according to claim 29, wherein
the file identifier is a full path name of the file.

33. The computer-readable medium according to claim 28, wherein
the access identifier contains an execution file name of the application as an identifier for identifying the application and an ID of the user as an identifier for identifying the user.

34. The computer-readable medium according to claim 28, further causing a computer to execute
an identifier addition process of acquiring the access identifier and file identifier from the access detection process that acquires the access identifier and a file identifier of a file after detecting the creation of the file by the application, and adding the access identifier to a file having the file identifier.

35. The computer-readable medium according to claim 34, wherein:
the access detection process examines whether the access identifier is added to the file after detecting that data is written to the file by the application, and transfers to the encryption/decryption process a writing identifier consisting of the access identifier, file identifier and data to be written when the access identifier is added to the file while returning an error identifier to the application when the access identifier is not added to the file; and
the encryption/decryption process searches the key storage device for the access identifier that is included in the writing identifier, acquires the encryption key from the key element extracted by the searching, and writes to the file the data encrypted with the acquired encryption key.

36. The computer-readable medium according to claim 34, wherein:
the access detection process examines whether the access identifier is added to the file after detecting that data is read from the file by the application, and transfers to the encryption/decryption process a reading identifier consisting of the access identifier and file identifier when the access identifier is added to the file while returning an error identifier to the application when the access identifier is not added to the file; and
the encryption/decryption process searches the key storage device for the access identifier that is included in the reading identifier, acquires the decryption key from the key element extracted by the searching, decrypts data read from the file with the acquired decryption key, and sends the data to the application.

37. The information leak prevention program computer-readable medium according to claim 35, wherein
the encryption and decryption keys each are a secret or public key, or the encryption and decryption keys are a common key.

38. The computer-readable medium according to claim 34, wherein
the file identifier is a full path name of the file.

39. The information leak prevention program computer-readable medium according to claim 34, wherein
the access identifier contains an execution file name of the application as an identifier for identifying the application and an ID of the user as an identifier for identifying the user.

40. A terminal comprising
the information leak prevention device claimed in claim 1.
